(19) United States
(12) Patent Application Publication
(10) Pub. No.: US 2009/0310108 A1
(43) Pub. Date: Dec. 17, 2009

(54) EXPOSURE APPARATUS AND METHOD OF MANUFACTURING DEVICE

(75) Inventor: Mitsuya Sato, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/481,125

(22) Filed: Jun. 9, 2009

(30) Foreign Application Priority Data
Jun. 13, 2008 (JP) 2008-155882

(51) Int. Cl. G03B 27/42

(52) U.S. Cl. 355/53

(57) ABSTRACT

A reticle stage, a substrate stage and a measurement device are controlled such that first measurement of the position of a surface of a substrate, positioning of the surface at an image plane of the projection optical system based on the first measurement, and an exposure are performed during a constant-speed scanning with respect to each shot area of a first group including a row of shot areas, second measurement of the position of the surface is performed during a constant-speed scanning with respect to a shot area belonging to a second group which is adjacent to the first group and includes a row of shot areas, and the constant-speed scanning and the exposure are started with respect to a shot area subjected to the second measurement, after positioning of the surface at the image plane is performed during acceleration of the substrate stage based on the second measurement.

### BACKGROUND OF THE INVENTION

1. Field of the Invention

The present invention relates to an exposure apparatus which exposes a substrate to light while a reticle and the substrate are scanned, and a method of manufacturing a device using the exposure apparatus.

2. Description of the Related Art

A conventional scanning exposure apparatus includes a focus measurement device which measures the surface position of a substrate at a measurement point spaced apart from an exposure area of a projection optical system and located on a side opposite to the exposure area in the scanning direction. The focus measurement device sequentially measures the surface level positions of shot areas on a wafer. When a surface portion of such a measured shot area reaches an exposure area by scanning operation, this apparatus sequentially controls the posture of the wafer so as to align the surface portion with an image plane of the projection optical system. The apparatus then projects a pattern formed on a reticle onto the wafer and exposes it to light. A conventional technique associated with an exposure apparatus is disclosed in Japanese Patent Laid-Open No. 2004-247476.

A conventional scanning exposure apparatus measures the surface level position of an exposure shot by using a focus measurement device on the front side in the scanning direction. The apparatus then needs to align the surface of the exposure shot with the image plane position of a projection optical system by Z-tilt driving of the wafer.

For this reason, it is necessary to perform scanning operation of an exposure shot at a constant speed from the position of a measurement point on the front side located before an exposure area and to perform scanning operation by a distance longer than the scanning distance for exposure. This hinders an improvement in the throughput of an exposure apparatus.

In order to solve this problem, some scanning exposure apparatuses employ a twin-stage arrangement including two stages, namely the first fine moving stage and the second fine moving stage to hold a wafer which is freely movable on one plane. This apparatus positions the first and second fine moving stages at a measurement position and an exposure position, respectively. At the measurement position, the apparatus executes focus measurement and alignment measurement, on the first fine moving stage, for a wafer placed on the stage. At the exposure position, the apparatus executes exposure operation, on the second fine moving stage, for the wafer placed on the stage. Upon completing measurement and exposure on the respective fine moving stages at the measurement and exposure positions, the apparatus moves the first fine moving stage after measurement to the exposure position and concurrently performs measurement and exposure again.

In an exposure apparatus with such a twin-stage arrangement, since there is no need to perform focus measurement at the exposure position, the scanning distance at the time of exposure can be almost equal to the scanning distance for exposure. This can implement high-speed exposure operation. However, such an exposure apparatus requires a large stage size because it requires two fine moving stages or the like. Since the apparatus is designed to perform focus measurement and alignment operation concurrently with exposure operation, it is rather difficult to suppress the vibrations of the respective fine moving stages.

### SUMMARY OF THE INVENTION

The present invention improves a throughput of an exposure apparatus by decreasing a constant-speed scanning distance.

According to the present invention, there is provided an exposure apparatus comprising a reticle stage configured to hold a reticle and to be moved, a substrate stage configured to hold a substrate and to be moved, a projection optical system configured to project light from the reticle onto an exposure area, a measurement device configured to measure a position of a surface of the substrate in an optical axis direction of the projection optical system with respect to a measurement point spaced apart from the exposure area in a direction opposite to a scanning direction of the substrate, and a controller, wherein shot areas are arrayed on the substrate two-dimensionally in a column direction along the scanning direction and a row direction perpendicular to the column direction, the apparatus performs an exposure of a shot area on the substrate to light in the exposure area during constant-speed scanning of the reticle stage and the substrate stage, the controller is configured to control the reticle stage, the substrate stage and the measurement device such that first measurement of the position of the surface, positioning of the surface at an image plane of the projection optical system based on the first measurement, and the exposure are performed during the constant-speed scanning with respect to each shot area of a first group including a row of shot areas, second measurement of the position of the substrate is performed during the constant-speed scanning with respect to a shot area belonging to a second group which is adjacent to the first group and includes a row of shot areas, and the constant-speed scanning and the exposure are started with respect to a shot area subjected to the second measurement, after positioning of the surface at the image plane is performed during acceleration of the substrate stage based on the second measurement.

According to the present invention, the throughput of the exposure apparatus can be improved by decreasing the constant-speed scanning distance.

Further features of the present invention will become apparent from the following description of exemplary embodiments with reference to the attached drawings.

### BRIEF DESCRIPTION OF THE DRAWINGS

FIG. 1 is a view for explaining scanning operation on the nth row in an exposure apparatus according to the first embodiment;

FIG. 2 is a view for explaining scanning operation on the (n+1)th row in the exposure apparatus according to the first embodiment;

FIG. 3 is a view for explaining scanning operation in a conventional exposure apparatus with a single-stage arrangement;

FIG. 4 is a view for explaining scanning operation in a conventional exposure apparatus with a twin-stage arrangement;

FIG. 5 is a view for explaining preliminary measurement in the exposure apparatus according to the first embodiment;

FIG. 6 is a view for explaining preceding measurement in the exposure apparatus according to the first embodiment;

FIG. 7 is a view for explaining measurement points in the exposure apparatus according to the first embodiment;

FIG. 8 is an overall schematic view of an exposure apparatus according to the present invention;

FIG. 9 is a view for explaining scanning operation on the nth row in an exposure apparatus according to the second embodiment; and

FIG. 10 is a view for explaining scanning operation on the (n+1)th row in the exposure apparatus according to the second embodiment.

### DESCRIPTION OF THE EMBODIMENTS

### Embodiment of Exposure Apparatus

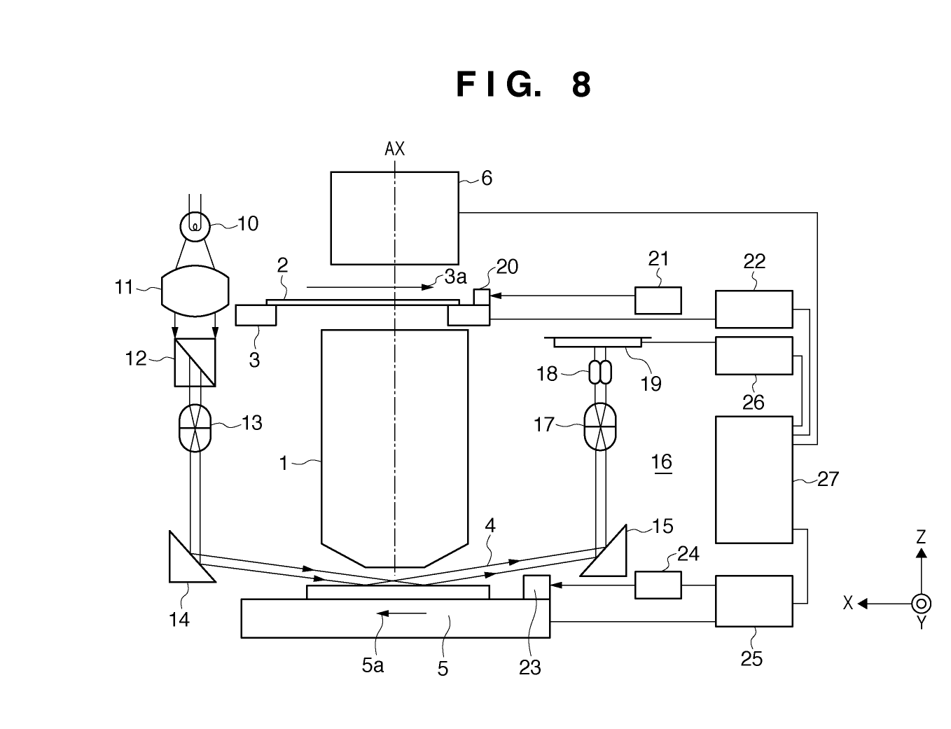

FIG. 8 is a partial schematic view of an example of an exposure apparatus according to the present invention which transfers a reticle pattern on a substrate while scanning a reticle and the substrate. The optical axis of a projection optical system 1 is represented by AX in FIG. 8, and an image plane of the system is perpendicular to the Z direction in FIG. 8.

A reticle 2 is held on a reticle stage 3. The projection optical system 1 reduces/projects a pattern on the reticle 2 to ¼ and forms an image on the image plane. A substrate (wafer) 4 whose surface is coated with a resist has many shot areas arrayed two-dimensionally in a column direction and a row direction perpendicular thereto. These shot areas are formed in a preceding exposure step and have the same pattern structure.

A substrate stage (wafer stage) 5 which holds a substrate (wafer) can be constituted by a chuck which chucks and fixes the wafer 4, an X-Y stage, a leveling stage, a rotating stage, and the like. The X-Y stage can translate in the X-axis direction and the Y-axis direction. The leveling stage can move in the Z-axis direction which is the optical axis (AX) direction of the projection optical system 1 and rotate about the X- and Y-axes. The rotating stage can rotate about the Z-axis. The wafer stage 5 can form a six-axis correction system for matching a reticle pattern image with an area to be exposed to light on a wafer.

Referring to FIG. 8, reference numerals 10 to 19 denote the respective components of a measurement device which is provided to detect the surface position and tilt of the wafer 4. The collimator lens 11 outputs a light beam from the light source 10 as a parallel light beam having an almost uniform intensity distribution on a cross-section. The slit member 12 in a prism shape is obtained by bonding a pair of prisms such that their inclined surfaces face each other. A plurality of openings (e.g., six pinholes) is formed in the bonded surfaces by using a light-shielding film made of chromium or the like. The optical system 13 of a bi-telecentric system guides six independent light beams passing through the plurality of pinholes of the slit member 12 to six measurement points on the surface of the wafer 4 via the mirror 14. Although FIG. 8 shows only two light beams, each light beam has three light beams in a direction perpendicular to the drawing surface.

The side where a reflected light beam from the wafer 4 is detected, that is, the respective components 15 to 19, will be described next. The light receiving optical system 16 of the bi-telecentric system receives six reflected light beams from the surface of the wafer 4 via the mirror 15. The stop 17 provided in the light receiving optical system 16 is commonly provided for the six measurement points. The stop 17 cuts high-order diffracted light beams (noise light) generated by a circuit pattern existing on the wafer 4.

The light beams passing through the light receiving optical system 16 of the bi-telecentric system have optical axes parallel to each other, and are formed again into spot light beams having the same size on the detection surface of the photoelectric conversion element group 19 via six independent correction lenses of the correction optical system group 18.

On the light receiving side (ranging from the component 16 to the component 18), tilt correction is performed such that each measurement point on the surface of the wafer 4 becomes conjugate with the detection surface of the photoelectric conversion element group 19. This prevents the position of a pinhole image on the detection surface from changing due to the local tilt of each measurement point. A pinhole image on the detection surface changes in response to a change in the level of each measurement point in the optical axis direction AX. The photoelectric conversion element group 19 can be constituted by six one-dimensional CCD line sensors.

A slit-scan exposure system will be described next. As shown in FIG. 8, the reticle 2 is fixed on the reticle stage 3 by chucking, and then scanned at a constant speed in the direction indicated by an arrow 3a (X-axis direction) within a plane perpendicular to the optical axis AX of the projection optical system 1. In addition, the reticle 2 is correction-driven to be scanned so as to always maintain a target coordinate position in a direction perpendicular to the arrow 3a (Y-axis direction: a direction perpendicular to the drawing surface).

It is possible to always measure the position information of the reticle stage 3 in the X and Y directions by externally irradiating an X-Y bar mirror 20 fixed on the reticle stage 3 with a plurality of laser beams from a reticle interferometer (XY) 21.

An illumination optical system 6 uses a light source to generate pulse light such as an excimer laser, and can be constituted by members (not shown) such as a beam shaping optical system, optical integrator, collimator, and mirror. The illumination optical system 6 can be made of a material which efficiently transmits or reflects pulse light in the far ultraviolet region.

The beam shaping optical system shapes the cross-sectional shape (including the size) of an incident beam into a desired shape. The optical integrator illuminates the reticle 2 with a light beam at a uniform illuminance upon homogenizing the light distribution characteristic of the light beam. A masking blade (not shown) in the illumination optical system 6 sets a rectangular illumination area in accordance with the chip size. A pattern on the reticle 2 partially illuminated in the illumination area is projected on the wafer 4 via the projection optical system 1.

A main control unit 27 scans the reticle 2 and the wafer 4 synchronously with the projection optical system 1 while adjusting the positions of a slit image of the reticle 2, in a predetermined area on the wafer 4, within an X-Y plane and in the Z-tilt direction. The main control unit 27 also controls the overall system to perform scanning exposure of the pattern on the reticle 2 while projecting the pattern on the wafer via the projection optical system 1. The main control unit 27, a reticle position control system 22 (to be described later), and a wafer position control system 25 (to be described later) constitute a controller which controls the reticle stage, wafer stage, and measurement device.

Calculating control data from position data from the interferometer 21 and an interferometer 24 and the position data of the wafer 4 will control the reticle position control system 22 and the wafer position control system 25, thereby positioning the pattern on the reticle 2 within an X-Y plane. The position data of the wafer 4 can be obtained from an alignment microscope (not shown).

When scanning the reticle stage 3 in the direction indicated by the arrow 3a, the wafer stage 5 scans in the direction indicated by an arrow 5a in FIG. 8 at a speed corrected by the reduction magnification of the projection optical system 1. The scanning speed of the reticle stage 3 is determined in favor of throughput from the width of the masking blade (not shown) in the illumination optical system 6 in the scanning direction and the sensitivity of the resist applied to the surface of the wafer 4.

Controlling the leveling stage in the wafer stage via the wafer position control system 25, based on the measurement result obtained by a surface position detection system 26 to detect the level data of the wafer 4, will position the pattern on the reticle in the Z-axis direction. Positioning the pattern on the reticle in the Z-axis direction is equivalent to positioning the pattern to match it with an image plane. The tilt of the wafer, placed near the slit in the scanning direction, in a direction perpendicular to the scanning direction and the level of the wafer in the optical axis AX direction are calculated from level data of three spot light beams for vertical position measurement. This calculation obtains a correction amount to the optimal image plane position at an exposure position, thus correcting the position of the wafer.

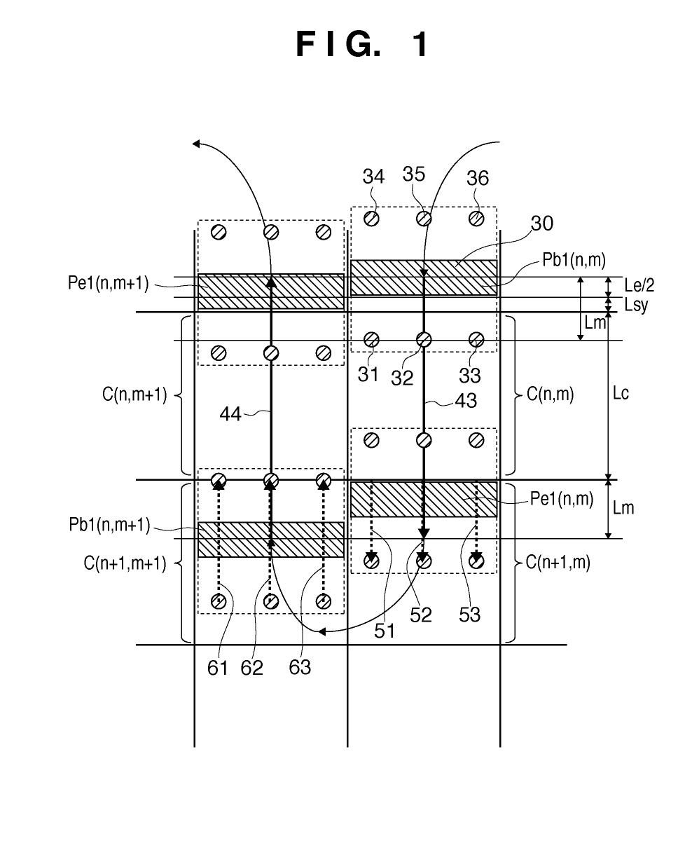

Scanning operation from the measurement of a substrate surface position to exposure in the exposure apparatus of the present invention with the above arrangement will be described below with reference to FIGS. 1 to 7.

Prior to the description of the present invention, outlines of scanning operation in conventional exposure apparatuses respectively having a signal-stage arrangement and a twin-stage arrangement will be described first.

(Conventional Exposure Apparatus with Single-Stage Arrangement)

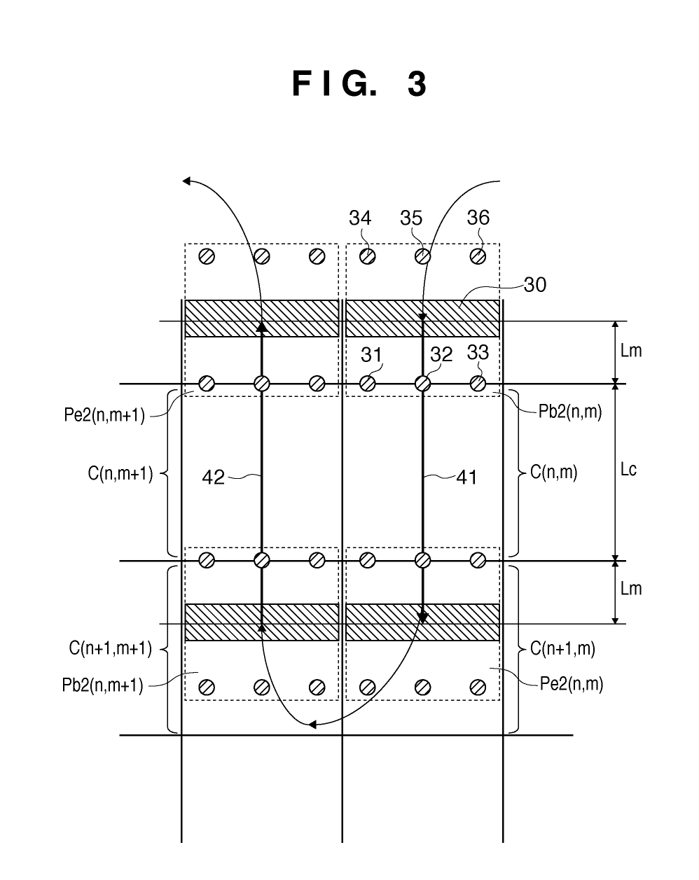

FIG. 3 is a plan view for explaining scanning operation in the conventional exposure apparatus with the single-stage arrangement. Reference numeral 30 denotes a slit-like exposure area; 31 to 33, measurement points for the measurement of substrate surface positions by the measurement device which are spaced apart from an exposure area on the substrate on its front side (first direction side); 34 to 36, measurement points for the measurement of substrate surface positions by the measurement device which are spaced apart from the exposure area on the substrate on its rear side (second direction side); and 41 and 42, constant-speed scanning operation areas in the scanning direction.

Reference symbol C(n, m) denotes the nth-row/mth-column shot area. A broken line rectangle Pb2(n, m) indicates the constant-speed scanning start position of the shot area C(n, m). A broken line rectangle Pe2(n, m) indicates the constant-speed scanning end position of the shot area C(n, m). Reference symbol Lc denotes the distance of a shot area in the scanning direction; and Lm, the distance from the center of an exposure area to each measurement point of the measurement device.

As is obvious from FIG. 3, when exposing the shot area C(n, m) to light, it is necessary to perform scanning operation of the constant-speed scanning exposure area 41 from the constant-speed scanning start position Pb2(n, m) to the constant-speed scanning end position Pe2(n, m). This is because after the end of exposure of the shot area C(n, m), it is necessary to position the measurement points 34 to 36 and the scanning exposure area 41 to a constant-speed scanning start position Pb2(n, m+1) to perform exposure of a shot area C(n, m+1). For this reason, the actual constant-speed scanning distance in the Y direction is given by Lc+2Lm.

(Conventional Exposure Apparatus with Twin-Stage Arrangement)

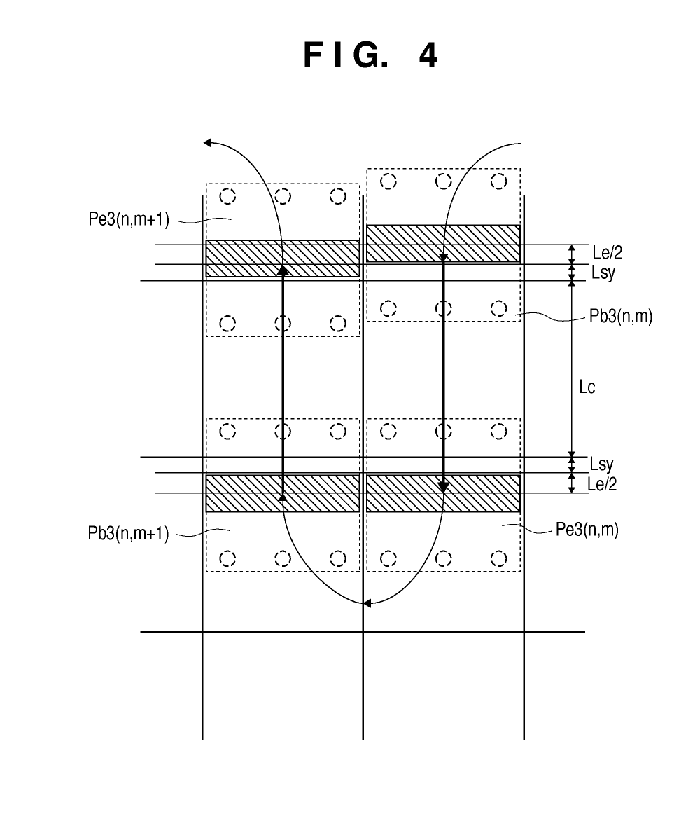

FIG. 4 is a view for explaining scanning operation in the exposure apparatus with the twin-stage arrangement which measures a substrate surface position at another position before exposure. Since no substrate surface position is measured at an exposure position, a measurement device is not placed around an exposure area. For easy comparison with FIG. 3, the broken lines indicate measurement points for the measurement of substrate surface positions by the measurement device.

Referring to FIG. 4, a broken line rectangle Pb3(n, m) indicates the constant-speed scanning start position of a shot area C(n, m), and a broken line rectangle Pe3(n, m) indicates the constant-speed scanning end position of the shot area C(n, m). Reference symbol Le denotes the width of an exposure area in the scanning direction; and Lsy, the distance in the scanning direction which is required for synchronous operation of a reticle and wafer.

In the exposure apparatus of this scheme, no measurement device is provided around an exposure area 30, and the measurement of a substrate surface position is completed in advance at another position. For this reason, it suffices to set a constant-speed scanning start position for exposure immediately before a shot area.

The actual constant-speed scanning distance in the Y direction is ideally given by Lc+Le, which is shorter than that in the conventional exposure apparatus.

In practice, when starting constant-speed scanning operation of a reticle and wafer, this apparatus starts control to establish positional synchronization so as to align the relative positions with each other. To establish this positional synchronization, the predetermined constant-speed scanning distance Lsy is required. The actual constant-speed scanning distance in the Y direction is given by Lc+Le+2Lsy. For this reason, the difference from the scanning distance in the conventional exposure apparatus with the single-stage arrangement is not so large at present.

Studies have therefore been made to shorten the scanning distance required for synchronous operation or start positional synchronous control before constant-speed scanning operation. There is therefore a possibility that the scanning distance will approach the ideal scanning distance represented by Lc+Le.

### First Embodiment

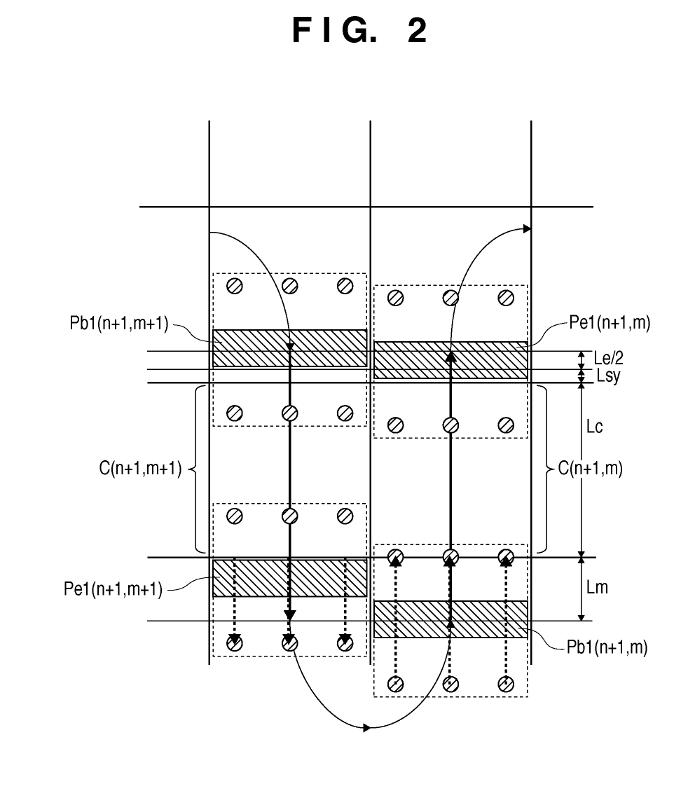

FIGS. 1 and 2 are views for explaining scanning operation in an exposure apparatus according to the present invention. FIG. 1 is a view for explaining scanning operation at the time of exposure on the nth row. FIG. 2 is a view for explaining scanning operation at the time of exposure on the (n+1)th row.

Referring to FIG. 1, reference numeral 30 denotes a slit-like exposure area; 31 to 33, measurement points for the measurement of substrate surface positions by a measurement device which are located on the front side of the exposure area; 34 to 36, measurement points for measurement of substrate surface positions by the measurement device which are located on the rear side (back side) of the exposure area; 43 and 44, constant-speed scanning operation areas in the scanning direction; 51, 52, and 53, preliminary measurement areas for substrate surface positions in a shot area C(n+1, m); and 61, 62, and 63, preliminary measurement areas for substrate surface positions in a shot area C(n+1, m+1). Reference symbol C(n, m) denotes the nth-row/mth-column shot area. A broken line rectangle Pb1(n, m) indicates the constant-speed scanning start position of the shot area C(n, m). A broken line rectangle Pe1(n, m) indicates the constant-speed scanning end position of the shot area C(n, m).

Reference symbol Lc denotes the distance of a shot area in the scanning direction; Lm, the distance from the center of an exposure area to a measurement point for the measurement of a substrate surface position by the measurement device; Le, the width of an exposure area in the scanning direction; and Lsy, the distance in the scanning direction which is required for synchronous operation of a reticle and wafer.

If a downward direction along the column direction in FIGS. 1 and 2 is defined as the first direction, and an upward direction in FIGS. 1 and 2 which is opposite to the first direction is defined as the second direction, the exposure apparatus performs scanning exposure while switching the scanning direction from the first direction to the second direction or from the second direction to the first direction every time the column to be scanned is switched.

When performing scanning exposure of the area C(n, m), the exposure apparatus of this embodiment measures surface positions at the measurement points 31 to 33 on the front side by using the measurement device while moving the measurement points 31 to 33 on the shot area C(n, m). When such a measured surface position is located in the exposure area 30 by scanning, the apparatus performs Z-tilt driving of a wafer stage 5 shown in FIG. 8 so as to match the surface position with an image plane of the projection optical system 1.

The exposure apparatus of this embodiment performs the above operation in the same manner as the conventional exposure apparatus, but performs the following special control in the second half part of a shot area.

The measurement points 31 to 33 on the front side pass through the shot area C(n, m) during scanning exposure. In this embodiment, concurrently with scanning exposure operation of the shot area C(n, m), the apparatus keeps measuring substrate surface positions on an (n+1)th shot area C(n+1, m) located one row below the shot area C(n, m) at the measurement points 31 to 33 on the front side.

This completes substrate surface position measurement on the shot area C(n+1, m) during scanning exposure in the shot area C(n, m). This operation completes substrate surface position measurement in preliminary measurement areas which are indicated by arrows 51, 52, and 53 in the shot area C(n+1, m).

The exposure apparatus starts exposure operation in a shot area C(n, m+1) after the above operation. In this case, it is necessary to perform constant-speed scanning operation from a constant-speed scanning start position Pb1(n, m+1) to a constant-speed scanning end position Pe1(n, m+1). In this case, the apparatus measures surface positions at the measurement points 34 to 36 while moving the measurement points 34 to 36 on the shot area C(n, m+1). If a measured surface position is located in the exposure area 30 by scanning operation, the apparatus performs Z-tilt driving of the wafer stage 5 so as to match the surface position with an image plane of the projection optical system 1.

The exposure apparatus of this embodiment performs the above operation in the same manner as the conventional exposure apparatus, but performs the following special control in the first half part of an exposure area.

When the measurement points 34 to 36 on the rear side in the scanning direction reach the shot area, the apparatus starts measuring substrate surface positions on the (n+1)th-row shot area C(n+1, m+1) one row below the above shot area from the measurement points 31 to 33 on the front side concurrently with scanning exposure operation.

This completes substrate surface position measurement on the shot area C(n+1, m+1) during scanning exposure in the shot area C(n, m+1). The above operation completes substrate surface position measurement in preliminary measurement areas which are indicated by arrows 61, 62, and 63 in the shot area C(n+1, m+1).

As described above, while performing scanning exposure in a shot area on a specific row, the exposure apparatus of this embodiment can complete substrate surface position measurement on the shot area one row below the specific row.

For this reason, as shown in FIG. 2, at the time of scanning exposure on the row one row below the specific row, it suffices to start constant-speed scanning operation immediately before a shot area. Therefore, as compared with the conventional exposure apparatus with the single-stage arrangement, the constant-speed scanning direction can be shorted. In this embodiment, the constant-speed scanning distance in the Y direction is given by Lc+Lm+Lsy+Le/2.

Therefore, as compared with a constant-speed scanning distance Lc+2Lm in the conventional exposure apparatus in which the measurement device for substrate surface positions is placed around an exposure area, the exposure apparatus of this embodiment can shorten the constant-speed scanning distance as follows:

(Lc+2Lm)−(Lc+Lm+Lsy+Le/2)=Lm−(Lsy+Le/2)

FIG. 2 shows a case in which optical scanning operation is performed in the shot area C(n+1, m+1), starting from the rear side to the front side. In this case, the apparatus uses measurement values in the preliminary measurement areas indicated by the arrows 61, 62, and 63 in FIG. 1.

The apparatus may perform exposure scanning operation in the shot area C(n+1, m), starting from the rear side to the front side, depending on the layout of the shot areas within the wafer. In this case, the apparatus uses measurement values in the preliminary measurement areas indicated by the arrows 51, 52, and 53 as the measurement values of substrate surface positions at the start of exposure.

In this embodiment, when performing scanning exposure in a shot area corresponding to one row, the apparatus measures a surface position in part of a shot area on an adjacent row. However, the number of rows to which an area to be exposed to light corresponds is not limited to one, and it suffices to perform scanning exposure for each group including at least a shot area corresponding to one row. While performing scanning exposure of the first group, the apparatus can perform preliminary measurement of surface positions in at least part of a shot area belonging to the second group before scanning exposure, which is adjacent to the first group.

This embodiment controls the measurement start timing of the measurement device such that the position of a measurement point for a surface position in the column direction does not vary among shot areas subjected to scanning exposure and remains at the same position in the shot areas. If the position of a measurement point in the column direction varies in shot areas subjected to scanning exposure, measurement errors vary due to the influence of circuit patterns formed in the shot areas. Since the errors are calculated in advance and correction is performed, it is necessary to align measurement points concerning all shot areas.

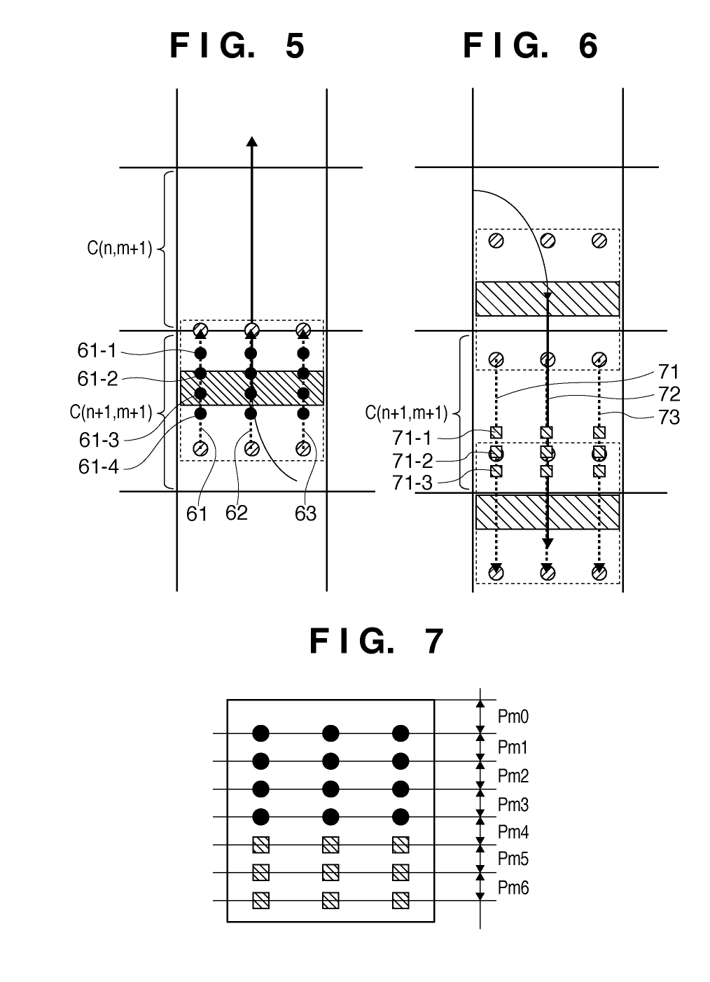

This state will be described below with reference to FIGS. 5 to 7. FIG. 5 is a view for explaining preliminary measurement in a portion which corresponds to the shot area C(n+1, m+1) and is extracted from FIG. 1 explaining scanning operation (on the nth row) in the first embodiment. FIG. 6 is a view for explaining preceding measurement immediately before exposure in a portion which corresponds to the shot area C(n+1, m+1) and is extracted from FIG. 2 explaining scanning operation (on the (n+1)th row) in the first embodiment. FIG. 7 is a view for explaining measurement points in the first embodiment. Reference numerals 61, 62, and 63 denote preliminary measurement areas for surface position measurement in the shot area C(n+1, m+1); and 71, 72, and 73, preceding measurement areas for surface position measurement to be performed immediately before exposure in the shot area C(n+1, m+1).

Reference numerals 61-1, 61-2, 61-3, and 61-4 denote discrete measurement points in a preliminary measurement area 61; and 71-1, 71-2, and 71-3, discrete measurement points in a preceding measurement area 71. Reference symbol Pm0 denotes the position of the first discrete measurement point in the shot area C(n+1, m+1); and Pm1 to Pm6, the distances between the discrete measurement points in the scanning direction.

In practice, measurement points similar to the measurement points 61-1 to 61-4 and the measurement points 71-1 to 71-3 exist in preliminary measurement areas 62 and 63 and preceding measurement areas 72 and 73, respectively. Since these measurement points are similar to the measurements points 61-1 to 61-4 and the measurement points 71-1 to 71-3, a repetitive description will be omitted.

Actual surface position measurement concerning the shot area C(n+1, m+1) is executed at the discrete measurement points 61-1 to 61-4 in the preliminary measurement area 61 at the start of exposure of the shot area C(n, m+1), as shown in FIG. 1.

In addition, at the discrete measurement points 71-1 to 71-3 in an area of the shot area C(n+1, m+1) which is not covered by the preliminary measurement area 61, surface positions are measured immediately before exposure as in the conventional exposure apparatus.

This apparatus controls the surface position measurement timings such that the positions of these discrete measurement points are located at specific distance intervals and at the identical positions in the row direction in all the shot areas, as shown in FIG. 7.

This eliminates the necessity to hold a correction value for the above pattern measurement error for each shot area in the exposure apparatus of this embodiment.

### Second Embodiment

The exposure apparatus of the first embodiment can shorten the constant-speed scanning distance as compared with the conventional exposure apparatus with the single-stage arrangement. However, there is still room for improvement. This will be described first with reference to FIG. 1 explaining the first embodiment.

The measurement points 34 to 36 are linearly moved at a constant speed on the shot area C(n, m+1) at the time of scanning exposure in the shot area C(n, m+1) so as to make the same pattern become a measurement target in each shot area.

For this purpose, it is necessary to set the constant-speed scanning start position Pb1(n, m+1) at a position (Lm) rather closer to the front end of a shot area.

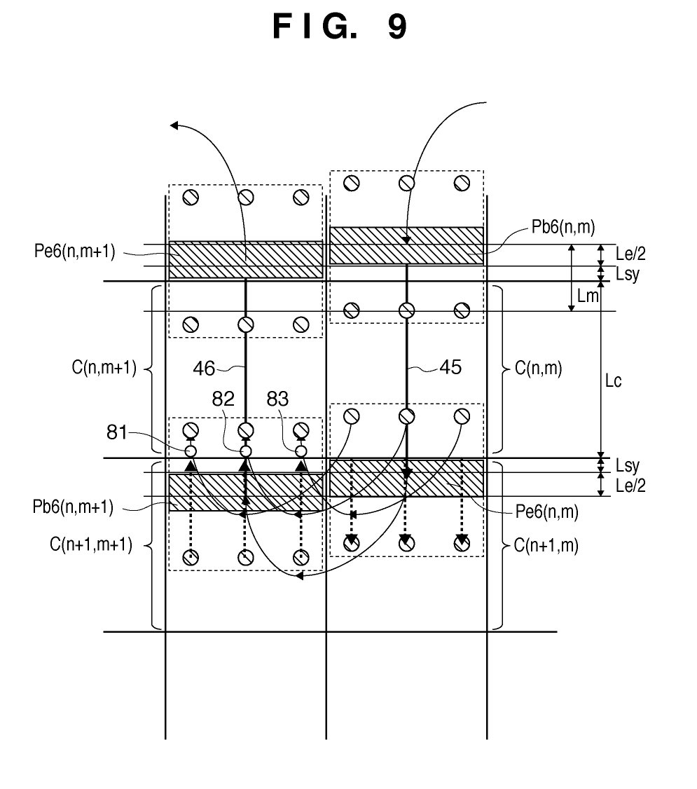

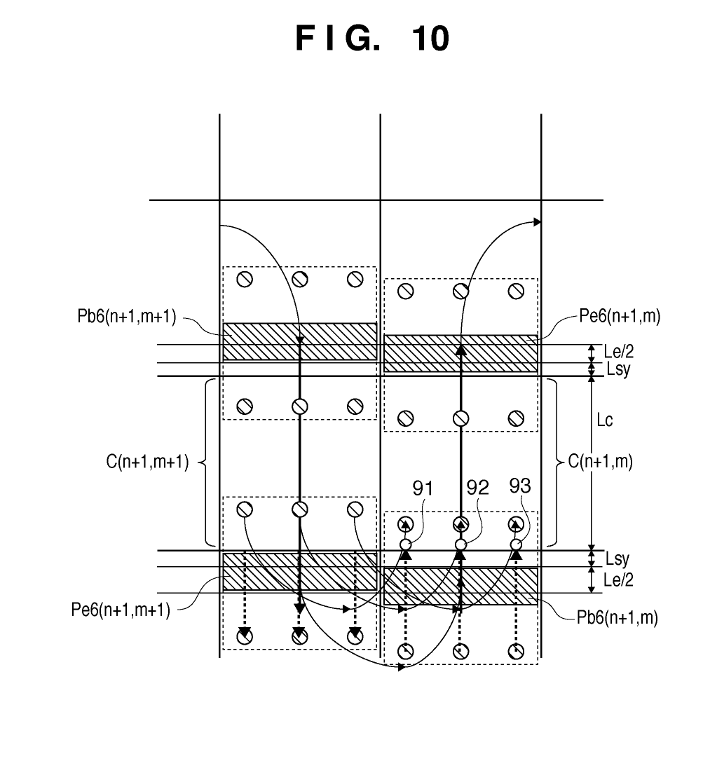

The second embodiment proposes a technique of shorting such a wasteful scanning distance. This state will be described with reference to FIGS. 9 to 10. FIGS. 9 to 10 are views for explaining the scanning operation of the exposure apparatus according to the second embodiment.

Reference numerals 45 and 46 denote constant-speed scanning operation areas. Reference symbol C(n, m) denotes the nth-row/mth-column shot area; Pb6(n, m), the constant-speed scanning start position of the shot area C(n, m); Pe6(n, m), the constant-speed scanning end position of the shot area C(n, m); Lc, the distance of the shot area in the scanning direction; Lm, the distance from the center of an exposure area to each measurement point; Le, the width of an exposure area in the scanning direction; and Lsy, the distance in the scanning direction which is required for synchronous operation of a reticle and wafer. Reference numerals 81, 82, and 83 denote the first measurement points in a shot area C(n, m+1); and 91, 92, and 93, the first measurement points in a shot area C(n+1, m).

The exposure apparatus of the second embodiment operates in the same manner as the exposure apparatus of the first embodiment at the time of scanning exposure of the shot area C(n, m), but operates differently at the start of exposure operation of the shot area C(n, m+1).

In the first embodiment, after the scanning position moves to a position Lm before the shot area C(n, m+1), the apparatus starts constant-speed scanning operation from the constant-speed scanning start position Pb1(n, m+1). In contrast to this, in the second embodiment, after the scanning position moves to a position (Lsy+Le/2) before the shot area C(n, m+1), the apparatus starts constant-speed scanning operation from the constant-speed scanning start position Pb6(n, m+1).

The constant-speed scanning distance in the Y direction in the second embodiment is therefore given by Lc+Le+2Lsy. That is, the constant-speed scanning distance is equal to the scanning distance in the exposure apparatus with the twin-stage arrangement including the two fine moving stages.

In this case, as shown in FIG. 9, if the movement amount in the X direction is large, the movement in the X direction may not have been completed at the start of constant-speed scanning operation for the shot area C(n, m+1) in the Y direction. That is, the first measurement points 81, 82, and 83 for surface positions in the lower portion of the shot area C(n, m+1) are shifted to the right side as a whole relative to the corresponding measurement points for substrate positions in the conventional exposure apparatus.

As shown in FIG. 10 as well, a similar phenomenon occurs in the shot area C(n+1, m). In this case, the first measurement points 91, 92, and 93 for surface positions in the lower portion of the shot area C(n+1, m) are shifted to the left as a whole relative to the corresponding measurement points for substrate positions in the conventional exposure apparatus.

In the exposure apparatus, a measurement error occurs by a circuit pattern in a shot area in which measurement is performed at a measurement point for a surface position. For this reason, this apparatus improves the positioning accuracy by performing correction for each measurement point by using correction data for this deceived amount. For this purpose, the apparatus performs control to locate a measurement point for a surface position at the same position in each shot area.

In the exposure apparatus of the second embodiment, however, as shown in FIGS. 9 and 10, the position of a measurement point in the column direction may vary depending on the scanning direction, resulting in the occurrence of two kinds of measurement points. This may cause a measurement error which varies depending on the position of a measurement point. For this reason, the exposure apparatus of the second embodiment holds two sets of correction data described above depending on the scanning direction. Selectively using correction data depending on the scanning direction will satisfy both the requirements for an improvement in throughput and the securement of high positioning accuracy.

Note that in the second embodiment, since the first measurement point for a surface position is shifted to the right or left, a Z-tilt driving amount is calculated so as to cancel an error caused by the shift.

In addition, the second embodiment of the present invention can be executed together with or independently of the first embodiment. Obviously, it is possible to use the first and second embodiments together or to selectively use only the second embodiment depending on the pattern state of a shot area, the size of a shot area, the scanning speed at the time of exposure, and the like.

The present invention can be applied not only to an exposure apparatus for semiconductor devices but also to an exposure apparatus for liquid crystal devices and the like.

A method of manufacturing a device such as a semiconductor integrated circuit device and liquid crystal display device using the above exposure apparatus will be exemplified next.

Devices are manufactured by an exposing step of transferring by exposure a pattern onto a substrate using the above exposure apparatus, a developing step of developing the substrate exposed in the exposing step, and other known steps (e.g., etching, resist removal, dicing, bonding, and packaging steps) of processing the substrate developed in the developing step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-155882, filed Jun. 13, 2008, which is hereby incorporated by reference herein in its entirety.

What is claimed is:

1. An exposure apparatus comprising:
a reticle stage configured to hold a reticle and to be moved;
a substrate stage configured to hold a substrate and to be moved;
a projection optical system configured to project light from the reticle onto an exposure area;
a measurement device configured to measure a position of a surface of the substrate in an optical axis direction of said projection optical system with respect to a measurement point spaced apart from the exposure area in a direction opposite to a scanning direction of the substrate; and
a controller,
wherein shot areas are arrayed on the substrate two-dimensionally in a column direction along the scanning direction and a row direction perpendicular to the column direction,
the apparatus performs an exposure of a shot area on the substrate to light in the exposure area during constant-speed scanning of the reticle stage and the substrate stage,
the controller is configured to control the reticle stage, the substrate stage and the measurement device such that
first measurement of the position of the surface, positioning of the surface at an image plane of the projection optical system based on the first measurement, and the exposure are performed during the constant-speed scanning with respect to each shot area of a first group including a row of shot areas,
second measurement of the position of the substrate is performed during the constant-speed scanning with respect to a shot area belonging to a second group which is adjacent to the first group and includes a row of shot areas, and
the constant-speed scanning and the exposure are started with respect to a shot area subjected to the second measurement, after positioning of the surface at the image plane is performed during acceleration of the substrate stage based on the second measurement.

2. An apparatus according to claim 1, wherein the controller is configured to control the measurement device such that the measurement device measures the position of the surface with respect to a shot area belonging to the second group at a measurement point spaced apart from the exposure area in a direction opposite to the scanning direction.

3. An apparatus according to claim 1, wherein the controller is configured to control the measurement device such that the measurement device measures the position of the surface with respect to a shot area belonging to the second group at a measurement point spaced apart from the exposure area in the same direction as the scanning direction.

4. An apparatus according to claim 1, wherein the controller is configured to control the measurement device such that a position of a measurement point in each shot area becomes constant in the column direction.

5. An apparatus according to claim 1, wherein the controller is configured such that if a position of a measurement point in a shot area varies in the column direction depending on the scanning direction, correction data is obtained in advance based on measurement values different in accordance with the scanning direction, and a measurement value obtained by the measurement device is corrected using the correction data in accordance with the scanning direction.

6. A method of manufacturing a device, the method comprising:
exposing a substrate to light by using an exposure apparatus;
developing the exposed substrate; and
processing the developed substrate to manufacture the device,
wherein the exposure apparatus includes:
a reticle stage configured to hold a reticle and to be moved;
a substrate stage configured to hold a substrate and to be moved;
a projection optical system configured to project light from the reticle onto an exposure area;
a measurement device configured to measure a position of a surface of the substrate in an optical axis direction of said projection optical system with respect to a measurement point spaced apart from the exposure area in a direction opposite to a scanning direction of the substrate; and
a controller, and
wherein shot areas are arrayed on the substrate two-dimensionally in a column direction along the scanning direction and a row direction perpendicular to the column direction,
the apparatus performs an exposure of a shot area on the substrate to light in the exposure area during constant-speed scanning of the reticle stage and the substrate stage,
the controller is configured to control the reticle stage, the substrate stage and the measurement device such that
first measurement of the position of the surface, positioning of the surface at an image plane of the projection optical system based on the first measurement, and the exposure are performed during the constant-speed scanning with respect to each shot area of a first group including a row of shot areas,
second measurement of the position of the substrate is performed during the constant-speed scanning with respect to a shot area belonging to a second group which is adjacent to the first group and includes a row of shot areas, and
the constant-speed scanning and the exposure are started with respect to a shot area subjected to the second measurement, after positioning of the surface at the image plane is performed during acceleration of the substrate stage based on the second measurement.

7. An exposure apparatus which, while a constant-speed scanning of a substrate on which shot areas are to be arrayed in a column direction parallel to a scanning direction and a row direction perpendicular to the column direction, and a reticle are performed, performs an exposure of the shot area to light in an exposure area via the reticle, the apparatus comprising:
a projection optical system configured to project light from the reticle onto the exposure area;
a measurement device configured to measure a position of a surface of the substrate in an optical axis direction of the projection optical system with respect to a measurement point spaced apart from the exposure area in a direction opposite to a scanning direction of the substrate; and
a controller,
wherein the controller is configured to control scanning of the reticle and the substrate and measurement by the measurement device such that
first measurement of the position of the surface, positioning of the surface at an image plane of the projection optical system based on the first measurement, and the exposure are performed during the constant-speed scanning with respect to each shot area of a first group including a row of shot areas,
second measurement of the position of the substrate is performed during the constant-speed scanning with respect to a shot area belonging to a second group which is adjacent to the first group and includes a row of shot areas, and
the constant-speed scanning and the exposure are started with respect to a shot area subjected to the second measurement, after positioning of the surface at the image plane is performed during acceleration of the substrate stage based on the second measurement.

8. A method of manufacturing a device, the method comprising:
exposing a substrate to light by using an exposure apparatus;
developing the exposed substrate; and
processing the developed substrate to manufacture the device,
wherein an exposure apparatus which, while a constant-speed scanning of a substrate on which shot areas are to be arrayed in a column direction parallel to a scanning direction and a row direction perpendicular to the column direction, and a reticle are performed, performs an exposure of the shot area to light in an exposure area via the reticle,
wherein the apparatus includes
a projection optical system configured to project light from the reticle onto the exposure area,
a measurement device configured to measure a position of a surface of the substrate in an optical axis direction of the projection optical system with respect to a measurement point spaced apart from the exposure area in a direction opposite to a scanning direction of the substrate, and
a controller, and
wherein the controller is configured to control scanning of the reticle and the substrate and measurement by the measurement device such that
first measurement of the position of the surface, positioning of the surface at an image plane of the projection optical system based on the first measurement, and the exposure are performed during the constant-speed scanning with respect to each shot area of a first group including a row of shot areas,
second measurement of the position of the substrate is performed during the constant-speed scanning with respect to a shot area belonging to a second group which is adjacent to the first group and includes a row of shot areas, and
the constant-speed scanning and the exposure are started with respect to a shot area subjected to the second measurement, after positioning of the surface at the image plane is performed during acceleration of the substrate stage based on the second measurement.
